(19) United States
(12) Patent Application Publication
(10) Pub. No.: US 2025/0350982 A1
(43) Pub. Date: Nov. 13, 2025

(54) METHODS AND APPARATUSES FOR INTERFERENCE MEASUREMENT

(71) Applicant: LENOVO (BEIJING) LIMITED, Beijing (CN)

(72) Inventors: Yu ZHANG, Beijing (CN); Haipeng LEI, Beijing (CN); Xiaodong YU, Beijing (CN); Bingchao LIU, Beijing (CN)

(21) Appl. No.: 18/860,953

(22) PCT Filed: Apr. 29, 2022
(86) PCT No.: PCT/CN2022/090509

§ 371 Date: Oct. 28, 2024

(51) Int. Cl. H04W 24/10; H04B 7/06; H04B 17/309; H04B 17/318; H04L 5/00

(52) U.S. Cl. CPC H04W 24/10; H04B 7/0626; H04B 17/328; H04B 17/346; H04L 5/0051

(57) ABSTRACT

Disclosed are methods and apparatuses for signal measurement configuration. An embodiment of the subject application provides a user equipment (UE). The UE includes: a processor and a wireless transceiver coupled to the processor, wherein the processor is configured to, with the wireless transceiver: receive a report setting for interference measurement (IM) results report; receive at least two resource settings associated with the report setting; wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resource; acquire at least one first value based on at least one first IM resource of the one or more first IM resources and at least one second value based on at least one second IM resource of the one or more second IM resources, wherein each of the at least one second IM resource is associated with one of the at least one first IM resource; determine at least one third value based on the at least one first value and the at least one second value; report the at least one third value and at least one resource index corresponding to the at least one second IM resource.

### TECHNICAL FIELD

The present disclosure generally relates to wireless communication technologies, and especially to methods and apparatuses for resource and report configuration for interference management in a wireless network.

### BACKGROUND OF THE INVENTION

Time Division Duplexing (TDD) is widely used in wireless networks. When operating TDD in a wireless network, only one transmission direction, that is, downlink (DL) or uplink (UL) is supported in a given time duration. However, allocation of a limited time duration for the UL transmissions would result in reduced coverage and increased latency. Therefore, it would be worth allowing the simultaneous existence of DL transmissions and UL transmissions in a given time duration, a.k.a. full duplex. More specifically, subband non-overlapping full duplex mode can be implemented in a wireless network, that is, the network can support simultaneous UL transmissions and DL transmissions occupying the non-overlapping subbands.

However, when operating subband non-overlapping full duplex mode, there may be mutual interference e.g., inter-subband cross-link interference (CLI) between some of the devices in the network. Thus, it is important for a network to manage the inter-subband CLI.

### SUMMARY

Various embodiments of the present disclosure provide solutions related to resource and report configuration for interference (e.g., inter-subband CLI) management in a wireless network.

According to some embodiments of the present disclosure, a user equipment (UE) is provided. The UE may include a processor and a wireless transceiver coupled to the processor. The processor is configured to, with the wireless transceiver: receive a report setting for interference measurement (IM) results report; receive at least two resource settings associated with the report setting; wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resource; acquire at least one first value based on at least one first IM resource of the one or more first IM resources and at least one second value based on at least one second IM resource of the one or more second IM resources, wherein each of the at least one second IM resource is associated with one of the at least one first IM resource; determine at least one third value based on the at least one first value and the at least one second value; report the at least one third value and at least one resource index corresponding to the at least one second IM resource.

In some embodiments, the one or more first IM resources are channel state information (CSI)-IM resources; and the one or more second IM resources are CSI-cross-link interference measurement (CSI-CLIM) resources.

In some embodiments, the at least one first value and the at least one second value are reference signal received power (RSRP) values.

In some embodiments, the at least one third value equates to the at least one second value minus the at least one first value.

In some embodiments, a time domain behavior for each resource of the one or more first IM resources and the one or more second IM resources is “periodic,” “semi-persistent,” or “aperiodic,” and is indicated in the first resource setting and the second resource setting respectively.

According to some embodiments of the present disclosure, a user equipment (UE) is provided. The UE may include a processor and a wireless transceiver coupled to the processor. The processor is configured to, with the wireless transceiver: receive a configuration of a set of IM resources at least including one or more first IM resources, wherein each of the one or more first IM resources is associated with one or more first sequences; acquire at least one first value based on at least one first IM resource of the one or more first IM resources; determining at least one second value based on the at least one first value respectively; and report the at least one second value and at least one of A) at least one first sequence index corresponding to at least one first sequence of the one or more first sequences associated with the at least one first IM resource or B) at least one resource index corresponding to the at least one first IM resource.

In some embodiments, for each of the one or more first IM resources, the configuration indicates at least: a resource index; a time domain behavior set to be “periodic”; and one or more first sequence indexes corresponding to the one or more first sequences.

In some embodiments, the at least one first value is an SRS RSRP value.

In some embodiments, the set of IM resources further includes one or more second IM resources, and each of the one or more second IM resources is associated with one or more second sequences, and wherein the processor is further configured to, with the wireless transceiver: transmit a reference signal based on one of the one or more second sequences on each of the one or more second IM resources.

In some embodiments, for each of the one or more second IM resources, the configuration indicates at least: a time domain behavior set to be “periodic”; and one or more second sequence indexes corresponding to the one or more second sequences.

In some embodiments, each of the one or more first IM resources is associated with one or more second sequences; and for each of the one or more first IM resources, the configuration further indicates: a time domain behavior set to “semi-persistent” and a slot level periodicity; and one or more first sequence indexes corresponding to the one or more first sequences; and one or more second sequence indexes corresponding to the one or more first sequences.

In some embodiments, for each of the one or more first IM resources, the processor is further configured to determine: a mapping for each occasion of a time window to one of the one or more first sequences or one of one of the one or more second sequences.

In some embodiments, for each of the one or more first IM resources and for each occasion within the time window, the processor is configured to acquire at least one first value or transmit a reference signal based on the mapping.

According to some embodiments of the present disclosure, a base station (BS) is provided. The BS may include a processor and a wireless transceiver coupled to the processor. The processor is configured to, with the wireless transceiver: transmit a report setting for IM and report and at least two resource settings associated with the report setting, wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resource; and receive at least one value and at least one resource index corresponding to at least one second IM resource of the one or more second IM resources.

According to some embodiments of the present disclosure, a base station (BS) is provided. The BS may include a processor and a wireless transceiver coupled to the processor. The processor is configured to, with the wireless transceiver: transmit a configuration of a set of interference measurement (IM) resources at least including one or more first IM resources, wherein each of the one or more first IM resources is associated with one or more first sequences; and receive the at least one first value and at least one of A) at least one first sequence index corresponding to at least one first sequence of the one or more first sequences associated with at least one first IM resource of the one or more first IM resource or B) at least one resource index corresponding to the at least one first IM resource.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary inter-subband CLI in a network.

FIG. 2 illustrates an exemplary method performed by a UE according to some embodiments of the present disclosure.

FIG. 3 illustrates an exemplary resource configuration according to some embodiments of the present disclosure.

FIG. 4 illustrates an exemplary method performed by a UE according to some embodiments of the present disclosure.

FIG. 5 illustrates an exemplary resource configuration according to some embodiments of the present disclosure.

FIG. 6 illustrates an exemplary resource configuration according to some embodiments of the present disclosure.

FIG. 7 illustrates an exemplary resource configuration according to some embodiments of the present disclosure.

FIG. 8 illustrates a simplified block diagram of an exemplary apparatus according to some embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

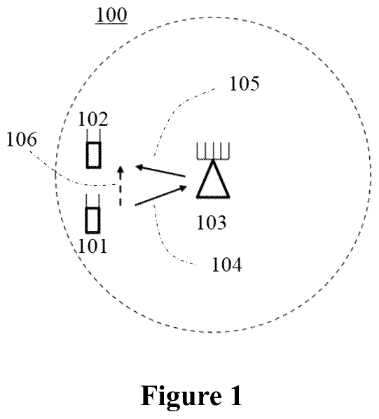

FIG. 1 illustrates an exemplary wireless network supporting a subband non-overlapping full duplex mode. In the wireless network, inter-subband CLI may exist.

Referring to FIG. 1, a wireless communications system 100 may include one or more UEs (e.g., UE 101, UE 102) and a BS 103. Although a specific number of the UE 101, UE 102, and the BS 103 are depicted in FIG. 1, it is contemplated that any number of the UEs and the BSs may be included in the wireless communications system 100.

In some embodiments of the present disclosure, the UE 101 and UE 102 may be devices in different forms or having different capabilities. According to some embodiments of the present disclosure, the UEs in the wireless communications system 100, e.g., UE 101, UE 102, may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, each of the UEs in the wireless communications system 100, e.g., UE 101 or UE 102 may be referred to as a portable wireless communication device, a smart phone, a cellular telephone, a flip phone, a device having a subscriber identity module, a personal computer, a selective call receiver, or any other device that is capable of transmitting and receiving information. In some embodiments, the UE 101 or UE 102 may include wearable devices, such as smart watches, fitness bands, optical head-mounted displays, or the like. Moreover, each of the UE 101 or UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 103 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 103 is generally a part of a radio access network that may include a controller communicably coupled to the BS 103.

The wireless communications system 100 may be compatible with any type of network that is capable of exchanging information between the BS 103 and the UEs (e.g., UE 101, and UE 102). For example, the wireless communications system 100 is compatible with a cellular telephone network, a Time Division Multiple Access (TDMA)-based network, a Code Division Multiple Access (CDMA)-based network, an Orthogonal Frequency Division Multiple Access (OFDMA)-based network, a 3GPP-based network, a 3GPP LTE network, a 3GPP 5G NR network, a satellite communications network, a high altitude platform network, and/or other communications networks. More generally, however, the wireless communications system 100 may implement some other open or proprietary communication protocols, for example, IEEE 802.11 family, WiMAX, among other protocols.

In some embodiments of the present disclosure, the BS 103 may be dispersed throughout a geographic area to form the wireless communications system 100 and may be a device in different forms or having different capabilities. The information exchanges between the BS 103 and the UEs (e.g., UE 101, or UE 102) in the wireless communications system 100 may include uplink (UL) transmissions (e.g., UL transmission 104) from the UE 101 to the BS 102, or downlink (DL) transmissions (e.g., DL transmission 105 from the BS 102 to the UE 102) over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple sub-bands within a carrier and each sub-band may include a number of consecutive RBs. The time intervals for the wireless communications system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols). The UL and DL transmissions may include physical channel transmissions and physical signal transmissions. A physical channel transmission or a physical signal transmission is transmitted on a set of basic time-frequency domain resources having a defined physical layer structure. Each basic time-frequency domain resource may be referred to as a resource element (RE) which may consist of one symbol in time domain and one subcarrier in frequency domain. A set of REs corresponding to a physical channel transmission or a physical signal transmission may span a number of symbols within a slot in time domain and a number of subcarriers within one or more sub-bands in frequency domain, that is, the physical channel transmission or the physical signal transmission may be transmitted in a number of symbols and within one or more sub-bands.

The physical signal transmissions may include reference signal (RS) transmissions, which are used for measurement. A UE may transmit a RS (e.g., sounding RS (SRS)) on a set of REs or receive a RS (e.g., SRS transmitted by another UE) on a set of REs. The set of REs corresponding to the RS transmission may be referred to as a resource or a measurement resource, which may be indicated to the UE by a resource configuration in a higher layer signaling. The time domain behavior of the resource is also indicated by the resource configuration and can be set to “periodic”, “semi-persistent” or “aperiodic”. When the time domain behavior of the resource is set to “periodic” or “semi-persistent”, there may be multiple occasions for transmitting or receiving the RS on the resource. The UE may acquire reference signal received power (RSRP) based on the resource. The UE may transmit an SRS or receive an SRS transmitted by another UE on a resource based on a sequence associated with the resource.

In the wireless communications system 100, subband non-overlapping full duplex mode is supported, that is, there may be simultaneous UL transmission(s) 104 (e.g., PUSCH transmission(s)) from the UE 101 to the BS 103 within subband a and DL transmission(s) 105 (e.g., PDSCH transmission(s)) from the BS 103 to the UE 102 within subband b; subband a and subband b are two non-overlapping adjacent subbands. However, the UL transmission(s) 104 transmitted from UE 101 may also arrive at UE 102, which may cause interference to the reception of the PDSCH transmission 105 at UE 102, so there may be inter-subband CLI 106 between the UE 101 and the UE 102; and UE 101 may be referred to as an aggressor UE in this case.

To reduce or avoid the inter-subband CLI 106, the BS 103 may plan a suitable schedule of the transmissions within the wireless communications system 100.

However, the BS cannot know whether there is inter-subband CLI between the UEs in advance, i.e., the BS cannot know which UE(s) may cause inter-subband CLI on other UE(s). Therefore, before planning the schedule of the transmissions within the wireless communication system, the BS needs to first determine where the inter-subband CLI exists. One way is that the UE(s) report measurement results based on some resources to the BS; to some extent, these measurement results indicates whether there are inter-subband CLI caused by the other UE(s). Based on the reported measurement results, the BS may determine where the CLI exists and thus plan a suitable schedule of the transmissions within a wireless communication system (e.g., the wireless communication system 100) to avoid or reduce the CLI.

The present disclosure provides solutions for resource and report configuration for the UE to acquire and report measurement results to the BS (e.g., BS 103), for example, when operating subband non-overlapping full duplex mode in the network (e.g., wireless communications system 100).

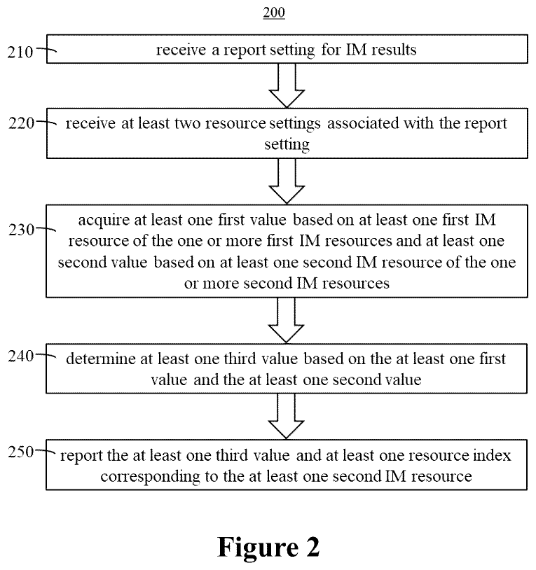

FIG. 2 illustrates a flowchart of an exemplary method 200 performed by a UE (e.g., UE 101) according to some embodiments of the present disclosure. Although method 200 is described herein with respect to a UE, it is contemplated that method 200 can be performed by other device with similar functionality. As shown in FIG. 2, method 200 includes operation 210, operation 220, operation 230, operation 240, and operation 250.

In operation 210, the UE receives a report setting for IM results report.

In operation 220, the UE receives at least two resource settings associated with the report setting; herein the at least two resource settings are both for IM, and include a first resource setting and a second resource setting. The first resource setting contains a first configuration of one or more (i.e., N1, a positive integer) first IM resources; the second resource setting contains a second configuration of one or more (i.e., N2, a positive integer) second IM resources, and each of the one or more second IM resources is associated with one of the one or more first IM resource. In some embodiments, the one or more first IM resources are CSI-IM resources; and the one or more second IM resources are CSI-CLIM resources; herein a CSI-CLIM resource means that other UE(s) may be indicated to transmit reference signals (e.g., SRS) in a resource corresponding to the CSI-CLIM resource, and the UE may receive leaked power from these reference signals based on the CSI-CLIM resource.

In operation 230, the UE acquires at least one first value based on at least one first IM resource of the one or more first IM resources and acquires at least one second value based on at least one second IM resource of the one or more second IM resources, wherein each of the at least one second IM resources is associated with one of the at least one first IM resource. In some embodiments, the at least one first value and the at least one second value are RSRP values.

In operation 240, the UE determines at least one third value based on the at least one first value and the at least one second value. In some embodiments, the at least one third value equates to the at least one second value minus the at least one first value.

In some embodiments, there is no strict order between operation 210 and operation 220. In some embodiments, operation 210 and operation 220 may be performed together. For example, in some cases, the UE receives a higher layer signaling including a report setting for interference measurement results report and at least two resource settings associated with the report setting together.

In some embodiments, a first value is RSRP value acquired based on a first IM resource. In some embodiments, another UE (e.g., UE 101) is indicated (by e.g., the BS) to transmit reference signals (e.g., SRS) to the BS on a resource corresponding to a second IM resource, and the acquired RSRP value based on the second IM resource includes leaked power from these reference signals transmission from the another UE. Thus, the third value can reflect the leaked power from these reference signals transmission from the another UE and indicate whether there is CLI from the another UE (e.g., UE 101) on the UE (e.g., UE 102) and how much is the CLI.

In operation 250, the UE reports the at least one third value and at least one resource index corresponding to the at least one second IM resource to the BS; the BS may determine whether there is CLI from the another UE (e.g., UE 101) on the UE (e.g., UE 102) and how much is the CLI.

In some embodiments, for each of the one or more first IM resources and the one or more second IM resources, the corresponding resource setting of the first resource setting and the second resource setting indicates a time domain behavior; the time domain behavior for each resource can be set to “periodic,” “semi-persistent,” or “aperiodic.”

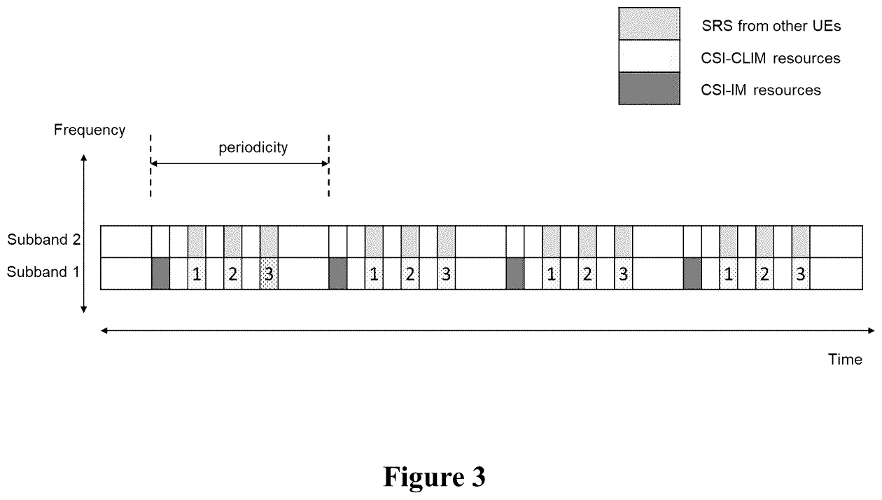

FIG. 3 illustrates an exemplary resource configuration for CLI measurement according to some embodiments of the present disclosure.

In this example, the UE (e.g., UE 102) receives a report setting for IM results report and receives two resource settings (a first resource setting and a second resource setting) associated with the report setting; the first resource setting contains a first configuration of a CSI-IM resource, the second resource setting contains a second configuration of three CSI-CLIM resources (including CSI-CLIM resource 1, CSI-CLIM resource 2, CSI-CLIM resource 3); the time domain behavior for each resource of the CSI-IM resource and the three CSI-CLIM resources is set to “periodic;” each CSI-CLIM resource is associated with the CSI-IM resource.

In this example, the CSI-IM resource and the three CSI-CLIM resources are within subband 1 in frequency domain. The other UE(s) transmit SRS(s) on resources in subband 2, wherein the resources in subband 2 correspond to the three CSI-CLIM resources within subband 1 respectively.

In this example, the UE can acquire:
a first RSRP value RSRP-0 based on the CSI-IM resource;
a second RSRP value RSRP-1 based on CSI-CLIM resource 1;
a second RSRP value RSRP-2 based on CSI-CLIM resource 2;
a second RSRP value RSRP-3 based on CSI-CLIM resource 3.

Then the UE may report the following information to the BS:
a third value RSRP-1′=RSRP-1−RSRP-0 and the index of the second resource CSI-CLIM resource 1;
a third value RSRP-2′=RSRP-2−RSRP-0 and the index of the second resource CSI-CLIM resource 2; and
a third value RSRP-3′=RSRP-3−RSRP-0 and the index of the second resource CSI-CLIM resource 3.

Based on these third values and the indexes of the associated second resources, the BS may determine where the inter-subband CLI exists, and may plan the suitable time of the transmission(s) or reception(s) of the involved UEs to reduce or avoid the inter-subband CLI.

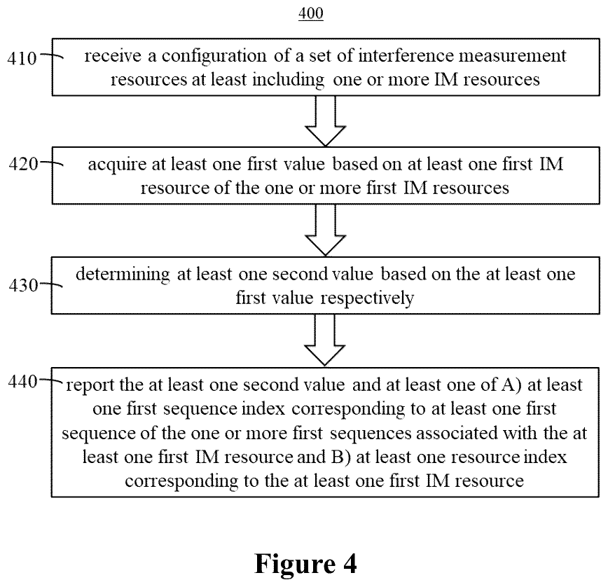

FIG. 4 illustrates a flowchart of another exemplary method 400 performed by a UE (e.g., UE 101) according to some embodiments of the present disclosure. Although method 400 is described herein with respect to a UE, it is contemplated that method 400 can be performed by other device with similar functionality. As shown in FIG. 4, method 400 includes operation 410, operation 420, operation 430, and operation 440.

In operation 410, the UE receives a configuration of a set of IM resources; the configuration at least includes one or more (e.g., N3, a positive integer) third IM resources, wherein each of the one or more third IM resources is associated with one or more first sequences. In some embodiments, a sequence is corresponding to a sequence index, and may be associated with a UE.

In some embodiments, for each of the one or more third IM resources, the configuration indicates at least:
a resource index;
a time domain behavior set to be “periodic”; and
one or more first sequence indexes corresponding to the one or more first sequences.

In some embodiments, the UE also receive a higher layer parameter “cliMeas” with the configuration, which indicates that the set of IM resources are used for CLI measurement.

In some embodiments, the UE may receive a higher layer signalling indicates that the set of IM resources are used for CLI measurement.

In operation 420, the UE acquires at least one fourth value based on at least one third IM resource of the one or more third IM resources. In some embodiments, each of the at least one fourth value is an SRS RSRP value.

In operation 430, the UE determines at least one fifth value based on the at least one fourth value respectively; to some extent, the at least one fourth value indicates power leaked from another UE and may be used to evaluate the CLI from the another UE to the UE. In some embodiments, the at least one fifth value is determined based on a wider BW than that where the at least one fourth value is acquired.

In operation 440, the UE reports the at least one fifth value and at least one of:
at least one first sequence index corresponding to at least one first sequence of the one or more first sequences which is associated with the at least one third IM resource;
for a third IM resource associated with more than one first sequences, the UE reports at least one fifth value determined based on the third IM resource and at least one first sequence index of more than one first sequence indexes corresponding to the more than one first sequences; each fifth value is associated with a first sequence (index); or.
at least one resource index corresponding to the at least one third IM resource.

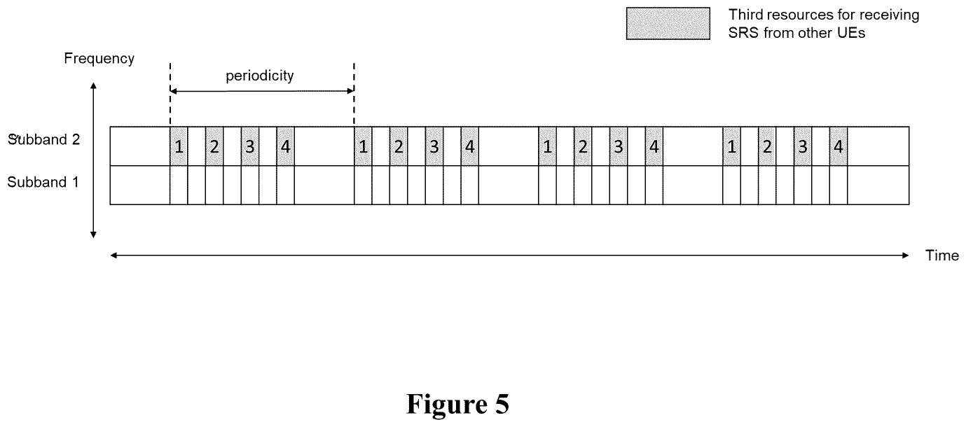

FIG. 5 illustrates an exemplary measurement resource configuration for CLI evaluation according to some embodiments of the present disclosure.

In this example, the UE (e.g., UE 102) receives a configuration of a set of IM resources at least including 4 (N3=4) third IM resources (i.e., SRS resource 1, SRS resource 2, SRS resource 3, and SRS resource 4) for intra-cell inter-subband CLI measurement, wherein each third IM resource is associated with one first sequence. For each third IM resources, the configuration indicates at least a time domain behavior set to be “periodic” and one first sequence indexes.

In this example, SRS resource 1, SRS resource 2, SRS resource 3, and SRS resource 4 are within subband 2.

In this example, the UE can acquire:
a fourth value SRS-RSRP-1 based on SRS resource 1, wherein SRS-RSRP-1 corresponds to UE 1 (e.g., UE 101);
a fourth value SRS-RSRP-2 based on SRS resource 2, wherein SRS-RSRP-2 corresponds to UE 2;
a fourth value SRS-RSRP-3 based on SRS resource 3, wherein SRS-RSRP-3 corresponds to UE 3; and
a fourth value SRS-RSRP-4 based on SRS resource 4, wherein SRS-RSRP-4 corresponds to UE 4.

In some embodiments, some of UE 1, UE 2, UE 3, and UE 4 may be the same UE (e.g., UE 101), or different UEs.

The UE may determine the fifth values SRS-RSRP-1′, SRS-RSRP-2′, SRS-RSRP-3′, and SRS-RSRP-4′ based on the fourth values SRS-RSRP-1, SRS-RSRP-2,SRS-RSRP-3, and SRS-RSRP-4 on a wider BW respectively. In some embodiments, the wider BW includes at least subband 1. To some extent, these fifth values can reflect the leaked power from the transmission on subband 2 to the reception on subband 1, and are thus associated with the CLI from UE 1, UE 2, UE 3, and UE 4 on the UE.

Then the UE may report the following information to the BS:
SRS-RSRP-1′ and the index of SRS resource 1;
SRS-RSRP-2′ and the index of SRS resource 2;
SRS-RSRP-3′ and the index of SRS resource 3; and
SRS-RSRP-4′ and the index of SRS resource 4.

Based on these fifth values and the indexes of the associated third resources, the BS may determine where the CLI exists, and may plan the suitable time of the transmission(s) or reception(s) of the involved UEs.

In some embodiments, a third IM resource is associated with more than one first sequences (more than one first sequence indexes); one advantage is to reduce the configuration overhead, e.g., the resources included in the configuration.

Referring back to FIG. 5 again, in another example, each of the 4 third IM resources (i.e., SRS resource 1, SRS resource 2, SRS resource 3, and SRS resource 4) is associated with two first sequences (two first sequence indexes):
SRS resource 1 is associated with two sequences having sequence index 1 and sequence index 2 respectively, wherein sequence index 1 and sequence index 2 correspond to UE 1 and UE 2 respectively;
SRS resource 2 is associated with two sequences having sequence index 3 and sequence index 4 respectively, wherein sequence index 3 and sequence index 4 correspond to UE 3 and UE 4 respectively;
SRS resource 3 is associated with two sequences having sequence index 5 and sequence index 6 respectively, wherein sequence index 5 and sequence index 6 correspond to UE 5 and UE 6 respectively; and
SRS resource 4 is associated with two sequences having sequence index 7 and sequence index 8 respectively, wherein sequence index 7 and sequence index 8 correspond to UE 7 and UE 8 respectively.

In some embodiments, some of UE 1, UE 2, UE 3, UE 4, UE 5, UE 6, UE 7, and UE 8 may be the same UE (e.g., UE 101), or different UEs.

In this example, the UE can acquire:
a fourth value SRS-RSRP-1-1 based on SRS resource 1;
a fourth value SRS-RSRP-1-2 based on SRS resource 1;
a fourth value SRS-RSRP-2-1 based on SRS resource 2;
a fourth value SRS-RSRP-2-2 based on SRS resource 2;
a fourth value SRS-RSRP-3-1 based on SRS resource 3;
a fourth value SRS-RSRP-3-2 based on SRS resource 3;
a fourth value SRS-RSRP-4-1 based on SRS resource 4; and
a fourth value SRS-RSRP-4-2 based on SRS resource 4.

Then the UE may determine the fifth values SRS-RSRP-1-1′, SRS-RSRP-1-2′, SRS-RSRP-2-1′, SRS-RSRP-2-2′, SRS-RSRP-3-1′, SRS-RSRP-3-2′, SRS-RSRP-4-1′, and SRS-RSRP-4-2′ based on the fourth values SRS-RSRP-1-1, SRS-RSRP-1-2, SRS-RSRP-2-1, SRS-RSRP-2-2, SRS-RSRP-3-1, SRS-RSRP-3-2, SRS-RSRP-4-1, and SRS-RSRP-4-2 on a wider BW respectively. To some extent, these fifth values can reflect the leaked power from the transmission on subband 2 to the reception on subband 1, and are thus associated with the CLI from UE 1, UE 2, UE 3, UE 4, UE 5, UE 6, UE 7, and UE 8 on the UE.

Then the UE may report the following information to the BS:
SRS-RSRP-1-1′ and sequence index 1;
SRS-RSRP-1-2′ and sequence index 2;
SRS-RSRP-2-1′ and sequence index 3;
SRS-RSRP-2-2′ and sequence index 4;
SRS-RSRP-3-1′ and sequence index 5;
SRS-RSRP-3-2′ and sequence index 6;
SRS-RSRP-4-1′ and sequence index 7; and
SRS-RSRP-4-2′ and sequence index 8.

Based on these fifth values and the associated sequence indexes, the BS may determine where the CLI exists, and may plan the suitable time of the transmission(s) or reception(s) of the involved UEs.

In some embodiments, when the BS transmits a configuration for the UE to measure CLI from the other UEs, the resource configuration may further configure resources for the UE to transmit reference signals (e.g., SRS) for other UEs to measure CLI. The advantages are, for example, to reduce the configuration overhead due to avoid multiple configurations and to improve the CLI evaluation efficiency within a wireless network (e.g., wireless communications system 100) due to implement multiple UEs measurement CLI simultaneously.

In some embodiments, the set of IM resources further includes one or more fourth IM resources in addition to the one or more third IM resources, and each of the one or more fourth IM resources is associated with one or more second sequences, and the UE may transmit a reference signal based on one of the one or more second sequences on each of the one or more fourth IM resources.

In some embodiments, for each of the one or more fourth IM resources, the configuration indicates at least:
a time domain behavior set to be “periodic”; and
one or more second sequence indexes corresponding to the one or more second sequences.

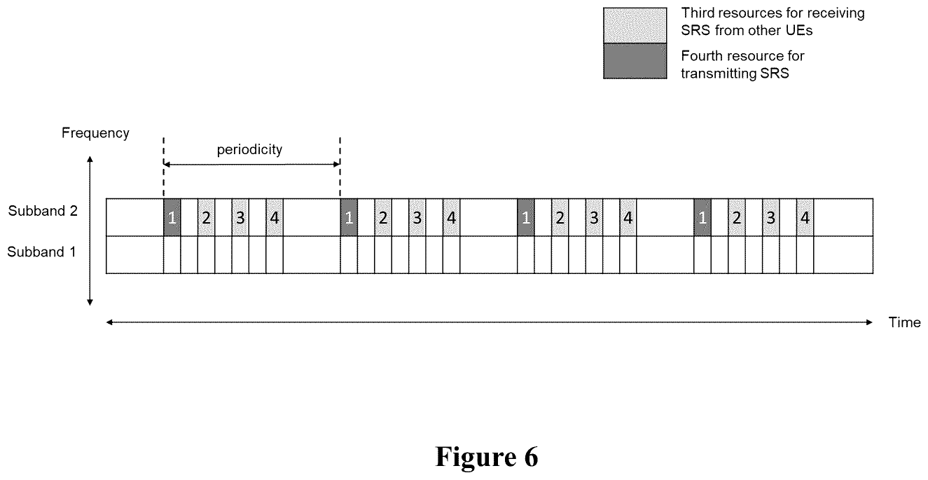

FIG. 6 illustrates an exemplary measurement resource configuration for the UE to acquire measurement results and transmit reference signals (e.g., SRS) for other UEs to perform CLI measurement according to some embodiments of the present disclosure.

In this example, the UE (e.g., UE 102) receives a configuration of a set of IM resources at least including 3 third IM resources (i.e., SRS resource 2, SRS resource 3, SRS resource 4) and 1 fourth IM resource (i.e., SRS resource 1); each third IM resource is associated with one first sequence, and the fourth IM resource is associated with a second sequence index; the 3 third IM resources are for intra-cell inter-subband CLI measurement, and the fourth IM resource is for other UEs to perform inter-subband CLI measurement.

In this example, for each of the IM resources, the configuration indicates at least a time domain behavior set to be “periodic.”

In this example, SRS resource 1, SRS resource 2, SRS resource 3, and SRS resource 4 are within subband 2 where the UE receives SRS from the other UE(s) or transmits SRS for other UE(s) to measurement CLI.

In this example, the UE can acquire:
a fourth value SRS-RSRP-2 based on SRS resource 2, wherein a first sequence index associated with SRS resource 2 corresponds to UE 2;
a fourth value SRS-RSRP-3 based on SRS resource 3, wherein a first sequence index associated with SRS resource 3 corresponds to UE 3; and
a fourth value SRS-RSRP-4 based on SRS resource 4, wherein a first sequence index associated with SRS resource 4 corresponds to UE 4.

In some embodiments, some of UE 2, UE 3, and UE 4 may be the same UE (e.g., UE 101), or different UEs.

The UE may determine the fifth values SRS-RSRP-2′, SRS-RSRP-3′, and SRS-RSRP-4′ based on the three fourth values SRS-RSRP-2, SRS-RSRP-3, and SRS-RSRP-4 on a wider BW respectively. In some embodiments, the wider BW includes at least subband 1. To some extent, these fifth values can reflect the leaked power from the transmission on subband 2 to the reception on subband 1, and are thus indicates the CLI from UE 2, UE 3, and UE 4 on the UE.

Then the UE may report the following information to the BS:
SRS-RSRP-2′, and the index of SRS resource 2 or an associated first sequence index;
SRS-RSRP-3′, and the index of SRS resource 3 or an associated first sequence index; and
SRS-RSRP-4′, and the index of SRS resource 4 or an associated first sequence index.

Based on the aforementioned information, the BS may determine where the CLI exists, and may plan the suitable time of the transmission(s) or reception(s) of the involved UEs.

Furthermore, the UE may transmit an SRS based on the associated second sequence for other UEs to measurement CLI.

In some embodiments, to reduce the measurement overhead, the UE does not need to periodically perform CLI measurement or transmit signals for other UE(s) to perform CLI measurement; the UE may perform these operations under for example a trigger or when certain condition(s) are met. For each of the set of IM resources, the configuration indicates at least:
a time domain behavior set to be “semi-persistent” and a slot level periodicity; and
one or more associated first sequences with corresponding first sequence indexes; and.
one or more associated second sequences with corresponding second sequence indexes.
   It can be seen that an IM resource of the configuration may be associated with both one or more first sequences and one or more second sequences; the IM resource may be used to acquire a fourth value or transmit an SRS; thus the configuration overhead is reduced.

In some embodiments, the UE may determine a CLI measurement window for example, in response to a trigger or a certain condition is met; within the CLIM window, there are one or more (i.e., N4, a positive integer) occasions.

Within an occasion, the UE may perform transmission or reception, it depends upon which kind of sequence index is associated with or mapped to. If the occasion is mapped to a first sequence index, the UE acquires a fourth value based on a third IM resource. If the occasion is mapped to a second sequence index, the UE transmits an SRS for other UE(s) to perform CLI measurement.

The UE determines a mapping for each occasion within the CLIM window to a first sequence index or a second sequence index. On the other hand, the BS indicates such a mapping.

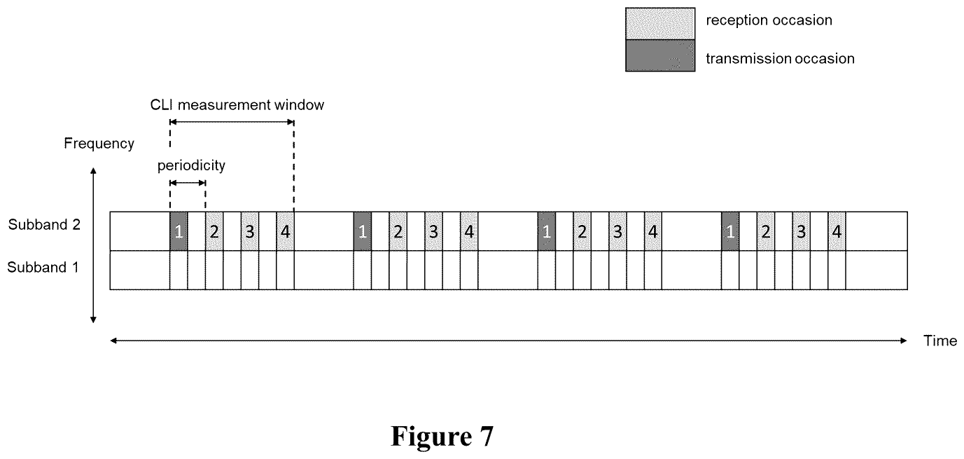

FIG. 7 illustrates an exemplary measurement resource configuration for the UE to acquire interference measurement results and transmit reference signals for other UEs to perform CLI measurement according to some embodiments of the present disclosure.

In this example, the UE (e.g., UE 102) receives a configuration of a set of IM resources at least including one SRS resource for intra-cell inter-subband CLI measurement, the UE may acquire a fourth value based on the SRS resource within an occasion if the corresponding occasion is mapped to a first sequence index, or the UE may transmit an SRS based on a second sequence index on the SRS resource within an occasion if the corresponding occasion is mapped to a second sequence index. The time domain behavior of the SRS resource is set to “semi-persistent.”

In this example, a reception occasion means an occasion mapped with a first sequence index; a transmission occasion means an occasion mapped with a second sequence index.

In this example, the SRS resource is associated with three first sequence indexes (first sequence index-1, first sequence index-2, and first sequence index-3) and a second sequence index; the UE determines that the three first sequence indexes (first sequence index-1, first sequence index-2, and first sequence index-3) are mapped to three reception occasions (occasion 2, occasion 3, and occasion 4) respectively, and a second sequence index is mapped to a transmission occasion (occasion 1). The BS indicates such a mapping.

In this example, the second sequence index corresponds to the UE (e.g., UE 102), and the three first sequence indexes correspond to UE 1, UE 2, and UE 3 respectively. In some embodiments, more than one of UE 1, UE 2, and UE 3 are the same UE (e.g., UE 101). In some embodiments, UE 1, UE 2, and UE 3 are different UEs.

In this example, the UE can acquire:
a fourth value SRS-RSRP-2 based on the SRS resource within occasion 2;
a fourth value SRS-RSRP-3 based on the SRS resource within occasion 3; and
a fourth value SRS-RSRP-4 based on the SRS resource within occasion 4.

The UE may determine fifth values SRS-RSRP-2′, SRS-RSRP-3′, and SRS-RSRP-4′ based on the three values SRS-RSRP-2, SRS-RSRP-3, and SRS-RSRP-4 on a wider BW respectively. In some embodiments, the wider BW includes at least subband 1. To some extent, these fifth values can reflect the leaked power from the transmission on subband 2 to the reception on subband 1, and thus indicate the CLI from UE 1, UE 2, and UE 3 on the UE.

Then the UE may report the following information to the BS:
SRS-RSRP-2′ and first sequence index-1;
SRS-RSRP-3′ and first sequence index-2; and
SRS-RSRP-4′ and first sequence index-3.

Based on the aforementioned information, the BS may determine where the CLI exists, and may plan the suitable time of the transmission(s) or reception(s) of the involved UEs.

Furthermore, the UE transmit an SRS on the SRS resource within occasion 1, for other UEs to measurement CLI.

It would be contemplated that the BS may perform methods corresponding to the aforementioned methods performed by a UE.

According to some embodiments of the present disclosure, the BS transmit a report setting for IM and report and at least two resource settings associated with the report setting, wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resource; and receive at least one value and at least one resource index corresponding to at least one second IM resource of the one or more second IM resources.

According to some embodiments of the present disclosure, the BS transmit a configuration of a set of IM resources at least including one or more third IM resources, wherein each of the one or more third IM resources is associated with one or more first sequences; and receive the at least one first value and at least one of A) at least one first sequence index corresponding to at least one first sequence of the one or more first sequences associated with at least one third IM resource of the one or more third IM resource or B) at least one resource index corresponding to the at least one third IM resource.

In some embodiments, the BS indicates a mapping for each occasion of a time window to a first sequence index or a second sequence index associated with an IM resource of the set of IM resources.

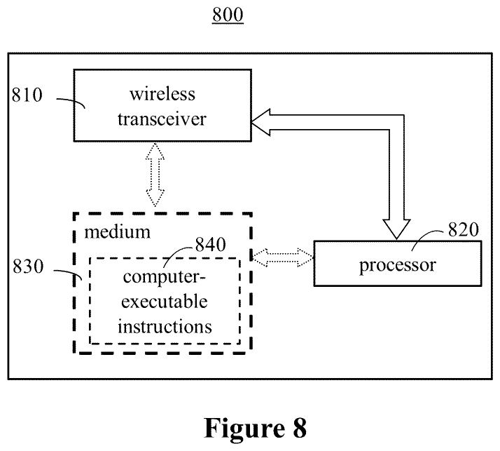

FIG. 8 illustrates a simplified block diagram of an exemplary apparatus 800 according to various embodiments of the present disclosure.

In some embodiments, apparatus 800 may be or include at least a part of a UE (e.g., UE 102) or similar device that can use the technology of the present disclosure.

In some embodiments, apparatus 800 may be or include at least a part of a BS (e.g., BS 103) or similar device that can use the technology of the present disclosure.

As shown in FIG. 8, apparatus 800 may include at least wireless transceiver 810 and processor 820, wherein wireless transceiver 810 may be coupled to processor 820. Furthermore, apparatus 800 may include non-transitory computer-readable medium 830 with computer-executable instructions 840 stored thereon, wherein non-transitory computer-readable medium 830 may be coupled to processor 820, and computer-executable instructions 840 may be configured to be executable by processor 820. In some embodiments, wireless transceiver 810, non-transitory computer-readable medium 830, and processor 820 may be coupled to each other via one or more local buses.

Although in FIG. 8, elements such as wireless transceiver 810, non-transitory computer-readable medium 830, and processor 820 are described in the singular, the plural is contemplated unless limitation to the singular is explicitly stated. In certain embodiments of the present disclosure, the apparatus 800 may further include other components for actual usage.

In some embodiments, the apparatus 800 is a UE or at least a part of a UE. Processor 820 is configured to cause the apparatus 800 at least to perform, with wireless transceiver 810, any method described above which is performed by a UE according to the present disclosure.

In some embodiments, the apparatus 800 is a BS or at least a part of a BS. Processor 820 is configured to cause the apparatus 800 at least to perform, with wireless transceiver 810, any method described above which is performed by a BS according to the present disclosure.

In various example embodiments, processor 820 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 820 may also include at least one other circuitry or element not shown in FIG. 8.

In various example embodiments, non-transitory computer-readable medium 830 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 830 may include, but is not limited to, an electric, a magnetic, an optical, an electromagnetic, an infrared, or a semiconductor system, apparatus, or device or any combination of the above.

Further, in various example embodiments, exemplary apparatus 800 may also include at least one other circuitry, element, and interface, for example antenna element, and the like.

In various example embodiments, the circuitries, parts, elements, and interfaces in exemplary apparatus 800, including processor 820 and non-transitory computer-readable medium 830, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive a report setting for a interference measurement (IM) results report;
receive at least two resource settings associated with the report setting, wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resource;
acquire at least one first value based on at least one first IM resource of the one or more first IM resources and at least one second value based on at least one second IM resource of the one or more second IM resources, wherein each of the at least one second IM resources is associated with one of the at least one first IM resource;
determine at least one third value based on the at least one first value and the at least one second value; and
report the at least one third value and at least one resource index corresponding to the at least one second IM resource.

2. The UE of claim 1, wherein the one or more first IM resources are channel state information (CSI)-IM resources; and the one or more second IM resources are cross-link interference measurement (CLIM) resources.

3. The UE of claim 1, wherein the at least one first value and the at least one second value are reference signal received power (RSRP) values.

4. The UE of claim 1, wherein the at least one third value equates to the at least one second value minus the at least one first value.

5. The UE of claim 1, wherein a time domain behavior for each resource of the one or more first IM resources and the one or more second IM resources is periodic, semi-persistent, or aperiodic, and is indicated in the first resource setting and the second resource setting, respectively.

6. A user equipment (UE) for wireless communication, comprising:
at least one memory; and
at least one processor coupled with the at least one memory and configured to cause the UE to:
receive a configuration of a set of interference measurement (IM) resources at least including one or more first IM resources, wherein each of the one or more first IM resources is associated with one or more first sequences;
acquire at least one first value based on at least one first IM resource of the one or more first IM resources;
determine at least one second value based on the at least one first value: and
report the at least one second value and at least one of: at least one first sequence index corresponding to at least one first sequence of the one or more first sequences associated with the at least one first IM resource; or at least one resource index corresponding to the at least one first IM resource.

7. The UE of claim 6, wherein for each of the one or more first IM resources, the configuration indicates at least:
a resource index;
a time domain behavior set to be periodic; and
one or more first sequence indexes corresponding to the one or more first sequences.

8. The UE of claim 6, wherein the at least one first value is a sounding reference signal (SRS) reference signal received power (RSRP) value.

9. The UE of claim 7, wherein the set of IM resources further includes one or more second IM resources, wherein each of the one or more second IM resources is associated with one or more second sequences, and wherein the at least one processor is further configured to cause the UE to:
transmit a reference signal based on one of the one or more second sequences on each of the one or more second IM resources.

10. The UE of claim 9, wherein for each of the one or more second IM resources, the configuration indicates at least:
a time domain behavior set to be periodic; and
one or more second sequence indexes corresponding to the one or more second sequences.

11. The UE of claim 6, wherein each of the one or more first IM resources is associated with one or more second sequences; and for each of the one or more first IM resources, the configuration further indicates:
a time domain behavior set to semi-persistent and a slot level periodicity;
one or more first sequence indexes corresponding to the one or more first sequences; and
one or more second sequence indexes corresponding to the one or more first sequences.

12. The UE of claim 11, wherein for each of the one or more first IM resources, the at least one processor is further configured to cause the UE to determine:
a mapping for each occasion within a time window to one of the one or more first sequences or one of one of the one or more second sequences-.

13. The UE of claim 12, wherein for each of the one or more first IM resources and for each occasion within the time window, the at least one processor is configured to cause the UE to acquire at least one first value or transmit a reference signal based on the mapping.

14. A base station (BS) for wireless communication, comprising:
at least one memory; and
at least one processor coupled with the at least one memory and configured to cause the BS to:
transmit a report setting for interference measurement (IM) results report and at least two resource settings associated with the report setting, wherein the at least two resource settings are both for IM, and include a first resource setting containing a first configuration of one or more first IM resources and a second resource setting containing a second configuration of one or more second IM resources, and each of the one or more second IM resources is associated with one of the one or more first IM resources; and
receive at least one value and at least one resource index corresponding to at least one second IM resource of the one or more second IM resources.

15. A base station (BS) for wireless communication, comprising:
at least one memory; and
at least one processor coupled with the at least one memory and configured to cause the BS to:
transmit a configuration of a set of interference measurement (IM) resources at least including one or more first IM resources, wherein each of the one or more first IM resources is associated with one or more first sequences; and
receive the at least one first value and at least one of: at least one first sequence index corresponding to at least one first sequence of the one or more first sequences associated with at
